(19) United States
(12) Patent Application Publication
(10) Pub. No.: US 2026/0038845 A1
(43) Pub. Date: Feb. 5, 2026

(54) FLOW BATTERY

(71) Applicant: THE ULTIMATE BATTERY COMPANY LTD, Hyde, Cheshire (GB)

(72) Inventors: Maurizio CUNNINGHAM-BROWN, Hyde, Cheshire (GB); Malcolm EARP, Hyde, Cheshire (GB); Keith ELLIS, Hyde, Cheshire (GB)

(21) Appl. No.: 18/998,329

(22) PCT Filed: Jul. 25, 2023
(86) PCT No.: PCT/GB2023/051964

§ 371 Date: Jan. 24, 2025

(30) Foreign Application Priority Data
Jul. 26, 2022 (GB) 2210927.6

(51) Int. Cl. H01M 4/86; B60L 50/64; H01M 8/18

(52) U.S. Cl. CPC H01M 4/86; B60L 50/64; H01M 8/188; H01M 2250/20

(57) ABSTRACT

A flow battery includes a first conductive plate and a second conductive plate. Each of the first and second conductive plates has an undulating surface formed with a first plurality of undulations which extend along a first axis of the conductive plate. and a second plurality of undulations which extend along a second, perpendicular axis of the conductive plate. The first and second conductive plates are arranged to form a first cell of the flow battery in which the respective undulating surfaces of the first and second conductive plates provide a cathode and a corresponding anode of the first cell, and define opposing walls of an electrolyte flow channel between the first and second conductive plates.

### BACKGROUND

The present teachings relate to batteries. More particularly, but not exclusively, the present teachings concern flow batteries.

In a flow battery, such as that disclosed by US 2013/0037760 A1, charged anolyte and catholyte is provided to a cell of the battery in use, while depleted anolyte and catholyte are removed from the cell. Such an arrangement provides the advantage of being able to conveniently “recharge” the flow battery by replacing the depleted electrolytes with charged electrolytes. Further advantages of flow batteries are that the electrolytes are generally non-volatile, and the cells are long lasting. While such batteries are suited for use in various applications requiring power storage, they may be particularly advantageous for use in electric vehicles, for example, where the process of replacing depleted electrolytes may be quicker than charging a conventional electric vehicle battery. However, flow batteries can have a relatively high mass and a relatively low energy density compared to other batteries which are conventionally used in electric vehicles.

The present teachings seek to mitigate the above-mentioned problems. Additionally, the present teachings seek to provide an improved flow battery and an improved electric vehicle.

### SUMMARY

According to a first aspect, there is provided a flow battery comprising a first conductive plate and a second conductive plate. Each of the first and second conductive plates comprise an undulating surface formed with a first plurality of undulations which extend along a first axis of the conductive plate, and a second plurality of undulations which extend along a second, non-parallel axis of the conductive plate. The first and second conductive plates are arranged to form a first cell of the flow battery in which the respective undulating surfaces of the first and second conductive plates provide a cathode and a corresponding anode of the first cell, and define opposing walls of an electrolyte flow channel between the first and second conductive plates.

Having undulations along two different axes allows for a greater surface area of contact between the plates and the electrolyte for area of the footprint of the plate, thereby enabling a more efficient design of battery in embodiments. For example, a flow battery according to embodiments comprises undulating anode and cathode surfaces which provide an increased surface area per nominal area in an x-y plane. Configured as such, a flow battery according to such embodiments may have a higher power density than an equivalent arrangement having planar anode and cathode surfaces. Accordingly, a flow battery according to embodiments may be smaller and more lightweight than prior art batteries having an equivalent power output. Flow batteries according to the present embodiments may find use in a range of applications. For example, in domestic or industrial off-grid energy storage or in electric vehicles.

It will be appreciated by the skilled person that a flow battery can also be used to charge (or recharge) electrolyte by connecting the flow battery to an appropriate power source and by reversing the flow of electrolyte through the cell(s) of the flow battery. For example, for electric vehicles, a traditional existing electric vehicle charging system as found at home, work, or commercially may therefore be used to recharge depleted electrolytes. Accordingly, flow batteries according to the present teachings may be used to produce charged electrolyte. This may be particularly advantageous for storing power produced by renewable energy sources in remote locations (for example, by off-shore wind farms, tidal or wave power, or solar panel arrays).

The electrolyte may flow between an electrolyte inlet and an electrolyte outlet. For example, charged anolyte may be provided to the cell via an anolyte inlet and depleted anolyte may be removed from the cell via an anolyte outlet. Charged catholyte may be provided to the cell via a catholyte inlet and depleted catholyte may be removed from the cell via a catholyte outlet. The battery may comprise at least one charged electrolyte storage tank. There may be a charged anolyte storage tank. There may be a charged catholyte storage tank. There may be a depleted anolyte storage tank. There may be a depleted catholyte storage tank.

The footprint of the first conductive plate may be an area A1. It will be understood that in the case where a plate has a rectangular planform, the area of the footprint of the plate will be the product of the straight line length and width of the rectangle (i.e. length x width). The surface area of the first conductive plate may be an area SA1. It will be understood that SA1>A1. It may be that SA1>110% A1. It may be that SA1 is between 110% and 150% the size of A1. For example, SA1 may be approximately 110%, 120%, 130%, 140%, or 150% of A1.

The footprint of the second conductive plate may be an area A2. It will be understood that in the case where a plate has a rectangular planform, the area of the footprint of the plate will be the product of the straight line length and width of the rectangle (i.e. length x width). The surface area of the second conductive plate may be an area SA2. It will be understood that SA2>A2. It may be that SA2>110% A2. It may be that SA2 is between 110% and 150% the size of A2. For example, SA2 may be approximately 110%, 120%, 130%, 140%, or 150% of A2. In most embodiments A1=A2. It may also be that SA1=SA2.

It may be that the geometry of the undulations along the first axis is different from the geometry of the undulations along the second axis. For example, the number of peaks and/or troughs per unit length may be different. The second axis may be perpendicular to the first axis.

Each plate may have a notional central plane which contains both the first and second axes, with the width and length of the plate extending in the plane and the thickness of the plate being transverse to the plane.

It may be that the undulating surface of at least one, and preferably both, of the first and second conductive plates comprise a first plurality of peaks and troughs which extend along the first axis of the conductive plate, and a second plurality of peaks and troughs which extend along the second axis of the conductive plate. It may be that a distance between a peak and an adjacent trough of the first plurality is different (for example by at least 20%, and preferably by more than 50%) to a distance between a peak and an adjacent trough of the second plurality. The average number of peaks and troughs per unit length, where there are such undulations, may be greater along the second axis as compared to along the first axis.

It may be that the first and second conductive plates are arranged such that their respective first axes are oriented substantially parallel with a flow axis along which electrolyte flows through the electrolyte flow channel. In such a case, it is preferred that the distance along the first axis between a peak and an adjacent trough is greater than a distance along the second axis between a peak and an adjacent trough.

It may be that the region defined between the first and second plates may be considered a tessellation of 3-D shapes, each having a similar 3-D shape, for example in the general form of a polyhedron. The tessellation may be generally rectangular or square in form. The tessellation may be generally hexagonal in form. The tessellation may be more complicated, effectively utilising two or more different 3-D shapes. The 3-D shapes may be curved, at least in part.

The first and second conductive plates are configured and arranged such that a flow path between the plates in the general direction of the first axis is less tortuous than a flow path between the plates in the general direction of the second axis.

The region defined between the first and second plates is shaped such that a typical path between the plates that is in the general direction of the first axis (e.g. the flow axis) is less tortuous than a typical path between the plates that is in the general direction of the second axis (e.g. perpendicular to the flow axis). This may assist the flow of electrolyte between the plates, whilst still proving an enhanced surface area of contact between the electrolyte and the plates.

The tortuousness of the undulating shape in a given direction (e.g. along the first axis or along the second axis) may be defined as the ratio of the separation of the peaks from the troughs in the direction of a third axis (the third axis being perpendicular to the first and second axes) to the separation of one peak from an adjacent peak in that given direction.

In other words, take a section of one peak to peak in the plane that contains both the given direction and the third axis, and the measure of the tortuousness may be a measure of the deviation from a straight line extending between the peaks.

The tortuousness of the shape of the first and/or second plates along the first axis (e.g. flow axis) may be a ratio in the range of 1:2 (i.e. more tortuous) to 1:40 (i.e. less tortuous), preferably in the range of 1:8 to 1:16, and optionally in the range of 1:6 to 1:25.

The tortuousness of the shape of the first and/or second plates along the second axis (e.g. perpendicular to the flow axis) may be a ratio in the range of 1:1.5 (i.e. more tortuous) to 1:25 (i.e. less tortuous), preferably in the range of 1:3 to 1:12, and optionally in the range of 1:2 to 1:20.

It is preferred that the shape of the first and/or second plates along the first axis is less tortuous, as judged by this measure, than along the second axis, for example so that the above-mentioned ratio for the first axis is about 150% to 300% of the ratio for the second axis, optionally about 200% (i.e. about twice the ratio).

In one embodiment, for example, the tortuousness of the shape of the surface of each of the first and second plates along the second axis (e.g. perpendicular to the flow axis) is a ratio of 1:6, whereas the ratio for the measure of tortuousness along the first axis (e.g. flow axis) is 1:12.

The undulations along the first axis of the conductive plate may therefore be elongated (less tortuous) in relation to the undulations along the second axis of the plate. If the undulations are too tightly spaced (or too tortuous) along the electrolyte flow axis, electrolyte flow through the cell may be adversely affected. It may therefore be advantageous to provide tighter and/or more tortuous undulations along the axis of the plate which is substantially perpendicular to the general flow direction of electrolyte.

The conductive plates may comprise a third axis which is oriented substantially perpendicular to a plane defined by the first and second axes. The distance between a peak and a trough along the third axis may be substantially equal for a peak and a trough spaced apart along the first axis and a peak and a trough spaced apart along the second axis. In some embodiments the distance between distance between peaks and troughs along the third axis may be different for different neighbouring peaks and troughs along the first axis. The distance between distance between peaks and troughs along the third axis may be different for different neighbouring peaks and troughs along the second axis.

The peaks and troughs are preferably evenly spaced along the first axis. The peaks and troughs are preferably evenly spaced along the second axis. It is preferred that the plates each have a shape such that any section, taken parallel to the first axis and perpendicular to the second axis and within a region that extends along the majority of, and preferably along at least 80% of, the distance across the plate along the second axis, contains multiple undulations (for example at least two peaks and at least two troughs). It is preferred that the plates each have a shape such that any section, taken parallel to the second axis and perpendicular to the first axis and within a region that extends along the majority of, and preferably along at least 80% of, the distance across the plate along the first axis, contains multiple undulations (for example at least two peaks and at least two troughs).

The maximum gradient relative to a nominal neutral plane (that extends in the directions of the first and second axis-which may be the same as the notional central plane mentioned above) may be different for a cross-section taken about a first plane (that is perpendicular to the neutral plane and containing the first axis) as compared to the maximum gradient relative to the nominal neutral plane for a cross-section taken about a second (e.g. perpendicular) plane (that is perpendicular to the neutral plane and containing the second axis). In embodiments, the magnitude of the maximum gradient of the undulating surface between a peak and a trough in a direction along the first axis may be different (for example by more than 20%, possibly more than 50%) from the magnitude of the maximum gradient of the undulating surface between a peak and a trough in a direction along the second axis. The ratio of the larger maximum gradient to the smaller maximum gradient may be in the range of 1.5:1 to 20:1, may be greater than 2:1, and possibly greater than 4:1.

It is preferred that the maximum gradient of the undulating surface between a peak and a trough in a direction along the flow axis (e.g. first axis) is less than the magnitude of the maximum gradient of the undulating surface between a peak and a trough in a transverse (e.g. perpendicular) direction (e.g. second axis). In embodiments, it is preferred that the magnitude of the maximum gradient of the anode and cathode surfaces is greatest in a direction substantially perpendicular to the direction of electrolyte flow. Providing the conductive plates with a reduced gradient along the axis of fluid flow is advantageous for ensuring optimised electrolyte flow along the flow axis.

It may be that at least one of the first and second conductive plates is an undulating plate having undulating surfaces on opposing sides of the plate. Both conductive plates may be undulating plates. The undulating plate may have a substantially uniform thickness.

The locations of the peaks of the undulating surface on a first side of the conductive plate may correspond to locations of troughs of the undulating surface on a second, opposite side of the conductive plate. The locations of the troughs of the undulating surface on a first side of the conductive plate may correspond to locations of peaks of the undulating surface on a second, opposite side of the conductive plate.

The flow battery may comprise a third conductive plate, wherein the first, second, and third conductive plates each comprise an undulating plate having undulating surfaces on opposing sides of the undulating plate. It may, for example, be that the second and third conductive plates are arranged to form a second cell of the flow battery in which the respective undulating surfaces of the second and third conductive plates provide a cathode and a corresponding anode of the second cell and define opposing walls of an electrolyte flow channel between the second and third conductive plates. In such an arrangement, the second conductive plate may thus form an anode of one of the first and second cells and a cathode of the other of the first and second cells.

The third conductive plate may be substantially identical in shape and/or structure to the first or second conductive plate. The flow battery may in principle comprise any number of conductive plates arranged to provide any number of cells, each cell being formed at least by opposing undulating surfaces two conductive plates which provide a cathode and a corresponding anode of the cell and which define opposing walls of an electrolyte flow channel between the two conductive plates.

The conductive plates may be formed from a conductive composite comprising a polymer and conductive filler particles. The filler particles may be distributed substantially uniformly throughout the polymer. The conductive composite forms a conductive polymer core of the conductive plate. Examples of suitable polymers are acrylonitrile butadiene styrene (ABS), polysulphone (PSU), polyethersulphone (PESU) or polyphenylsulphone (PPS). Examples of suitable conductive filler particles are carbon fibre, carbon nanotubes, graphene, carbon, buckminsterfullerene or any other carbonaceous material, semiconductor or metallic substance. The conductive filler may comprise a material coated with a metal, metal alloy, semiconductor mineral or oxide. The conductive filler may alternatively or additionally comprise metallic fibres or powders. Examples of suitable metals are Gold, Nickel, Copper, Lead, Tin, Iron, Cobalt, Magnesium, Zinc, Titanium, Silver, Aluminium or alloys of these metals. The conductive filler particles may have a diameter of up to 50 μm, and generally between 7 μm and 10 μm. The percentage of conductive filler particles within the conductive composites by volume can be between 2% and 50% but generally between 20% and 30%. The conductive plates may be formed by injection moulding, compression moulding or other manufacturing process, such as additive manufacturing or 3D printing.

The conductive plates may alternatively be manufactured by overlaying a non-conductive material with a conductive mesh or lattice structure.

The anode and cathode surfaces of the conductive plates may be provided by a technique of cold application, vapour deposition, electroplating, sputtering or other methods of depositing metal onto a substrate, e.g. the conductive composite or conductive polymer core. The anode and cathode surfaces may comprise different materials. The anode or cathode surfaces may comprise one or more of the following Fe, Mg, Ca, Zn, Al, Na, Ni in pure or in alloy form. Alternatively or additionally, the anode or cathode surfaces may be provided by a non-metal, which may include one or more of C, Si, or any other suitable anode or cathode material.

The flow battery may be configured such that there are defined a catholyte flow channel adjacent to the cathode surface and an anolyte flow channel adjacent to the anode surface. The flow battery may comprise one or more pumps for pumping catholyte along the catholyte flow channel in a first flow direction and for pumping anolyte along the anolyte flow channel in a second flow direction. The first flow direction may be generally parallel to the second flow direction, and may be in an opposite direction.

The flow battery may comprise a separator membrane between the first and second conductive plates. The separator membrane, which is permeable to anions and cations during charge and discharge of the battery may before formed from a permeable polymer, such as polypropylene, cellulose. In some embodiments the separator membrane may comprise glass fibre reinforcement. The separator membrane may, for example, comprise the polymer sold under the trade name “Nafion”, or other suitable ion exchange membrane materials available to the skilled person.

Such a flow battery may be configured with a catholyte flow channel between the cathode surface and the separator membrane on a first side of the separator membrane and with an anolyte flow channel between the anode surface and the separator membrane on a second, opposite side of the separator membrane.

In embodiments, the electrolyte flow channel may comprise a catholyte flow channel and an anolyte flow channel separated by a membrane. In other embodiments, however, concerning what may be described as a “membraneless arrangement”, the cathode and anode define opposing walls of a single electrolyte flow channel. These embodiments may include arrangements in which mixing of anolyte and catholyte is controlled by means of a colaminar flow or the use of immiscible liquids.

If provided, the separator membrane may be substantially planar. If provided, the separator membrane may be formed with a first plurality of undulations which extend along a first axis of the membrane, and with a second plurality of undulations which extend along a second, perpendicular axis of the membrane.

Such undulations formed in the membrane may be complementarily shaped with respect to the undulating surface of at least one of the first and second conductive plates. It may be that the membrane is arranged such that a peak of the undulating surface of the membrane is received within a trough of the undulating surface of at least one of the first and second conductive plates. It may be that the membrane is arranged such that a peak of at least one of the first and second conductive plates is received within a trough of the undulating surface of the membrane. The membrane may be arranged such that peaks (e.g. at least the majority of the peaks—optionally all of the peaks) of the undulating surface of the membrane are received within troughs of the undulating surfaces of one or both of the first and second conductive plates. The membrane may be arranged such that troughs (e.g. at least the majority of the troughs—optionally all of the troughs) of the undulating surface of the membrane are received within peaks of the undulating surfaces of one or both of the first and second conductive plates. The membrane may have a shape that follows the peaks and troughs of both the first and second conductive plates, for example in the case where the shape of the peaks and troughs of first plate match and follow those of the second plate. Where the battery comprises a plurality of cells formed from a plurality of undulating conductive plates, an undulating membrane may be provided between each of the undulating conductive plates.

The separator membrane may be held in place using a lattice structure. Where the separator membrane is substantially planar, the lattice structure may also be substantially planar. Where the separator membrane is formed with undulations, the lattice structure may also comprise undulations or be shaped in some other way to hold the undulating shape of separator membrane. The lattice structure may be formed with a plurality of undulations which are complementarily shaped with respect to the undulations formed in the membrane. A surface of the membrane may be supported upon the lattice structure. A peak of the lattice structure may be received within a trough on of the surface of the membrane. A peak on the surface of the membrane may be received within a trough of the lattice structure. The lattice structure may serve as a scaffold structure which secures the separator membrane in place, thereby preventing the separator membrane from coming into contact with either anode or cathode. The lattice structure may hold the separator membrane at a defined distance from the anode and cathode to enable efficient ion exchange. The lattice structure may be constructed of a non-conductive inert material which may be a polymer, which may be Acrylonitrile butadiene styrene, Polyphenylene sulphide, or any other polymer which remains inert in the chemical environment of the flow battery cell.

The flow battery described and claimed herein may be relatively lightweight and have a relatively high power density. For example, the flow battery of the present teachings may deliver at least 320 Watt-hours of energy per litre of electrolyte, which makes their application in a range of applications requiring energy storage particularly appealing. The first cell may comprise a cell inlet through which electrolyte is provided to the cell and a cell outlet through which electrolyte leaves the cell. The undulating surfaces of the first and second conductive plates may be configured such that the electrolyte flow channel changes direction in an x-y plane between the cell inlet and cell outlet. Alternatively or additionally, the undulating surfaces of the first and second conductive plates may be configured such that two or more separate electrolyte flow channels are provided between the cell inlet and cell outlet. The undulating surfaces may include surfaces which are, serpentine, parallel serpentine, spiral, spiral serpentine, leaf integrated, parallel murray-branched, lounge like integrated, or leaf-like. The undulating surfaces may define flow region(s) or flow channel(s) which are, serpentine, parallel serpentine, spiral, spiral serpentine, leaf integrated, parallel murray-branched, lounge like integrated, or leaf-like.

In accordance with a second aspect there is provided an electric or hybrid vehicle comprising a flow battery according to the first aspect.

The electric or hybrid vehicle may be an electric road vehicle, watercraft, aircraft, spacecraft, or any other type of electric vehicle (such as an e-scooter, e-bike or the like). In such a vehicle there may be one or more flow batteries, in accordance with the first aspect, which are configured to provide electric power for propelling the vehicle, or to assist the propulsion of the vehicle, and preferably being the principal source of power for the vehicle.

The present teachings also provide a method of refuelling such a vehicle as mentioned above. Such a method may include using a pump at a charging station to extract depleted electrolyte fluid from the vehicle and using a pump, which could be the same pump or a different pump, at the charging station to supply charged electrolyte fluid to the vehicle. Where the electric vehicle is an electric road vehicle, the infrastructure for refuelling the vehicle could therefore be very similar to present day (petrol/diesel) fuel stations and could allow existing fuel stations to be repurposed. However, it should be appreciated that the flow battery can also be recharged by connecting the flow battery to an appropriate power source and by reversing the flow of electrolyte through the cell(s). It will be understood that the vehicle will typically comprise one or more tanks for holding depleted electrolyte fluids and one or more tanks for holding charged electrolyte fluids. The one or more flow batteries may share common tanks. There may for example be a number of charged catholyte tanks that supply a greater number of flow batteries and/or flow battery cells.

It will of course be appreciated that features described in relation to one aspect of the present teachings may be incorporated into other aspects. For example, the method may incorporate any of the features described with reference to the flow battery and vice versa.

According to a third aspect, there is provided a conductive plate for a flow battery, the conductive plate may be formed from a conductive composite, the conductive composite comprising: a polymer; and conductive filler particles distributed substantially uniformly throughout the polymer, wherein the conductive composite forms a conductive polymer core of the conductive plate, and wherein the conductive plate comprises an undulating surface formed with a first plurality of undulations which extend along a first axis of the conductive plate, and a second plurality of undulations which extend along a second, perpendicular axis of the conductive plate.

The conductive polymer core may comprise anode and cathode surfaces, for example undulating anode and cathode surfaces, on opposing surfaces thereof.

The polymer may comprise one or more of acrylonitrile butadiene styrene (ABS), polysulphone (PSU), polyethersulphone (PESU) or polyphenylsulphone (PPS).

The conductive filler particles may comprise one or more of carbon fibres, carbon nanotubes, graphene, carbon, buckminsterfullerene or any other carbonaceous material, semiconductor or metallic substance.

The conductive filler particles may comprise a material coated with a metal, metal alloy, semiconductor mineral or oxide.

The conductive filler particles may comprise metallic fibres or powders.

The conductive filler particles may comprise Gold, Nickel, Copper, Lead, Tin, Iron, Cobalt, Magnesium, Zinc, Titanium, Silver, Aluminium or alloys of one or more of these metals.

The conductive filler particles may have a diameter of up to 50 μm, for example generally between 7 μm and 10 μm.

The conductive composite may comprise conductive filler particles by volume can be between 2% and 50% but generally between 20% and 30%.

The conductive plates may be formed by injection moulding, compression moulding or other manufacturing process, such as additive manufacturing or 3D printing. The conductive plates may alternatively be manufactured by overlaying a non-conductive material with a conductive mesh or lattice structure.

The anode and cathode surfaces of the conductive plate may be provided by a technique of cold application, vapour deposition, electroplating, sputtering or other methods of depositing metal onto conductive composite.

The anode and cathode surfaces may comprise different materials.

The anode or cathode surfaces may comprise one or more of the following Fe, Mg, Ca, Zn, Al, Na, Ni in pure or in alloy form.

The anode or cathode surfaces may be provided by a non-metal, which may include one or more of C, Si, or any other suitable anode or cathode material.

The conductive plate may be a bipolar plate.

The conductive plate of the third aspect may comprise one or more of the optional features of the conductive plate of the first aspect.

### BRIEF DESCRIPTION OF THE DRAWINGS

Embodiments will now be described by way of example only with reference to the accompanying schematic drawings of which:

FIG. 1 is a schematic drawing of a flow battery according to a first embodiment;

FIG. 2 is a schematic drawing of an electric vehicle comprising the flow battery of FIG. 1;

FIG. 3 is a schematic drawing showing two cells of the flow battery of FIG. 1;

FIG. 4 shows a bipolar plate of the battery of FIG. 1 in isolation;

FIG. 5 is a cross-sectional view of the bipolar plate of FIG. 3 taken along the length of the bipolar plate;

FIG. 6 is a cross-sectional view of the bipolar plate of FIG. 3 taken across the width of the bipolar plate;

FIG. 7 is a schematic drawing showing a cell of a flow battery according to a second embodiment;

FIG. 8 is a schematic drawing showing the separator membrane of the cell of FIG. 7 and the polymer lattice upon which the separator membrane is mounted;

FIGS. 9A to 9D show examples of some of the shapes of undulations with which the conductive plates of batteries according to embodiments of the present teachings could be formed; and

FIGS. 10A to 10D show examples of flow patterns of the electrolytes through flow cells of batteries according to the present teachings.

### DETAILED DESCRIPTION

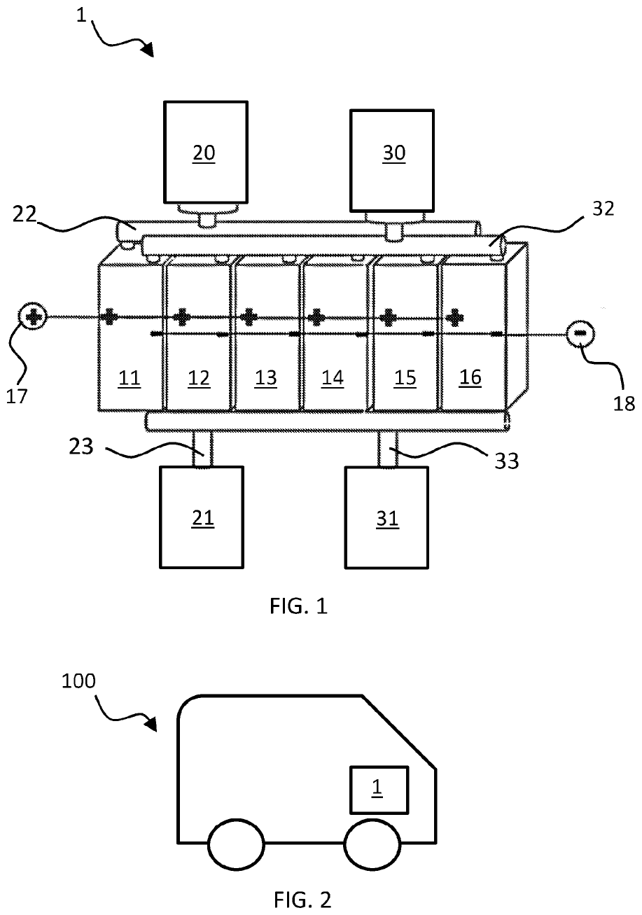

A flow battery 1 according to an embodiment is shown schematically in FIG. 1. The flow battery 1 comprises at least one cell. In the embodiment illustrated, the flow battery 1 includes six cells 11-16, but it will be appreciated that any suitable number of cells may be used, for example, one, two, three, four, five, seven or any number of cells.

The flow battery 1 includes a charged anolyte tank 20, a charged catholyte tank 30, a depleted anolyte collector 21, and a depleted catholyte collector 31. The battery 1 is configured so that, in use, charged anolyte and charged catholyte are provided to the cells 11-16 via a charged anolyte conduit 22 and a charged catholyte conduit 32, respectively. Depleted anolyte is removed from the cells 11-16 and fed into the anolyte collector 21 by a depleted anolyte conduit 23 and depleted catholyte is removed from the cells 11-16 and fed into the catholyte collector 31 by a depleted catholyte conduit 33. The battery 1 has a positive terminal 17 and a negative terminal 18 for connection to an electrical load. The flow battery 1 is particularly suited for use in an electric vehicle 100, as depicted in FIG. 2. For example, the flow battery 1 may be retro-fitted as a replacement powertrain in an existing powertrain space of an internal combustion engine or electric vehicle. In order to recharge the electric vehicle 100, the depleted anolyte and catholyte are removed from the collectors 21 and 31, and charged anolyte and catholyte are provided to the tanks 20, 30. However, the flow battery 1 may in principle find use in any suitable power storage application.

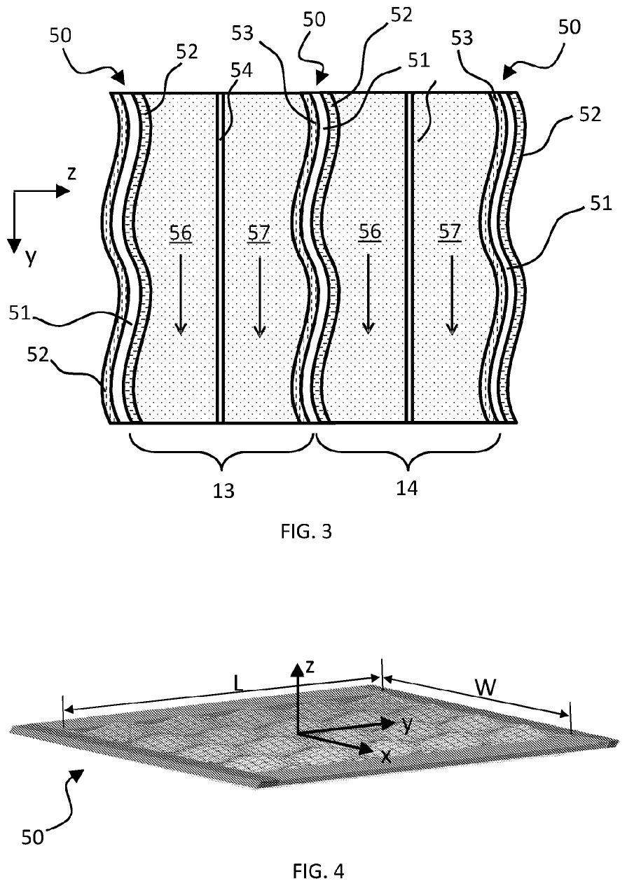

Referring to FIG. 3, each cell 11-16 includes a first conductive plate 52 and a second conductive plate 53. The first and second conductive plates 52, 53 provide a cathode surface 52 and an anode surface 53, respectively. Each of the first and second conductive plates 52, 53 defines an undulating surface formed with a first plurality of undulations which extend along a first axis of the conductive plate 52, 53, and a second plurality of undulations which extend along a second, perpendicular axis of the conductive plate 52, 53. The first and second conductive plates 52, 53 are arranged to form a cell of the flow battery 1 in which the respective undulating surfaces of the first and second conductive plates 52, 53 provide a cathode and a corresponding anode of the cell, and define opposing walls of an electrolyte flow channel between the first and second conductive plates 52, 53. The first and second conductive plates 52, 53 may be arranged such that peaks (e.g. at least the majority of the peaks-optionally all of the peaks) of the undulating surface of the first conductive plate 52 are received within or aligned with troughs of the undulating surfaces the second conductive plate 53 of the respective cell 11-16. The first and second conductive plates 52, 53 may be arranged such that troughs (e.g. at least the majority of the troughs-optionally all of the troughs) of the first conductive plate 52 are received within peaks of the second conductive plate 53 of the respective cell 11-16.

Cells 12-15 of the battery are each formed by a pair of bipolar plates 50. Put another way, the first and/or second conductive plates may be bipolar plates 50. Each bipolar plate 50 includes a cathode surface 52 and an anode surface 53. A cathode surface of each cell 12-15 is provided by a first bipolar plate 50 and an anode surface 53 is provided by a second bipolar plate 50 which is spaced apart from the first bipolar plate 50. This arrangement of bipolar plates is best illustrated in FIG. 3, which shows two of the cells 13, 14 of the battery 1 in isolation. The two cells 13, 14 are formed by three bipolar plates 50.

Each bipolar plate 50 comprises a conductive polymer core 51. The conductive polymer core 51 may be formed from a conductive composite. The conductive composite may comprise a polymer, and conductive filler particles distributed substantially uniformly throughout the polymer. The polymer may comprise one or more of acrylonitrile butadiene styrene (ABS), polysulphone (PSU), polyethersulphone (PESU) or polyphenylsulphone (PPS). The conductive filler particles may comprise one or more of carbon fibres, carbon nanotubes, graphene, carbon, buckminsterfullerene or any other carbonaceous material, semiconductor or metallic substance. The conductive filler particles may comprise a material coated with a metal, metal alloy, semiconductor mineral or oxide. The conductive filler particles may comprise metallic fibres or powders. The conductive filler particles may comprise Gold, Nickel, Copper, Lead, Tin, Iron, Cobalt, Magnesium, Zinc, Titanium, Silver, Aluminium or alloys of one or more of these metals. The conductive filler particles may have a diameter of up to 50 μm, for example generally between 7 μm and 10 μm. The conductive composite may comprise conductive filler particles by volume can be between 2% and 50% but generally between 20% and 30%. In some embodiments, the anode or cathode surfaces, i.e. the first and second conductive plates, may comprise one or more of the following Fe, Mg, Ca, Zn, Al, Na, Ni in pure or in alloy form. Alternatively, the anode or cathode surfaces 52, 53 may be provided by a non-metal, which may include one or more of C, Si, or any other suitable anode or cathode material.

In the present embodiments, the conductive polymer core may be formed from injection moulded acrylonitrile butadiene styrene (ABS) containing about 20% by volume of uniformly dispersed zinc particles. A conductive zinc coating is provided on opposite sides of the conductive polymer core 51 to provide a cathode surface 52 on one side of the bipolar plate 50 and an anode surface 53 on the opposite side of the bipolar plate 50. In other embodiments, the conductive polymer core may be formed from other suitable conductive polymer arrangements and other conductive coatings may be used to provide the anode and cathode surfaces.

In each cell 11-16, a separator membrane 54 in the form of a planar sheet of Nafion is provided between the cathode and anode surfaces 52, 53. The space between the membrane 54 and the cathode surface 52 is filled with catholyte 56 and the space between the membrane 54 and the anode surface 53 is filled with anolyte 57. The electrolyte used for the catholyte and anolyte is ambipolar zinc-polyiodide. In other embodiments, other suitable electrolytes may of course be used.

The battery 1 is configured such that the catholyte 56 and anolyte 57 flow through the cells from top to bottom, in the orientation the cells are shown in FIGS. 1 and 3, as indicated by the arrows in FIG. 3. A catholyte flow channel is therefore defined between the membrane 54 and cathode surface 52 and an anolyte flow channel is defined between the membrane 54 and the anode surface 53. Cells 12-15, which have neighbouring cells on either side, are each arranged in this way. However, cells 11 and 16, which only have a neighbouring cell on one side are formed by one bipolar plate and one monopolar plate. In particular, cell 16 comprises a cathode surface 52 provided by a bipolar plate shared with neighbouring cell 15 and an anode surface provided by a monopolar plate. Cell 11 comprises an anode surface 53 provided by a bipolar plate shared with neighbouring cell 12 and a cathode surface provided by a monopolar plate. The monopolar plates may be similarly arranged to the bipolar plates 50, but having a conductive coating on one side only to provide a cathode or anode, as necessary.

The bipolar plates 50 each comprise a conductive polymer core 51 formed by a plate having undulations which extend both along a length axis y of the plate and along a width axis x of the plate. Configured as such, the conductive polymer core 51 comprises a plurality of peaks and troughs which are arranged in the x-y plane. This arrangement may result in giving the conductive polymer core 51 the general shape of an egg-box. The x and y axes, which define a nominal plane of the conductive polymer core 51 are labelled in FIG. 4, along with the z-axis, which extends perpendicularly to the x-y plane. The undulations increase area of the cathode surface 52 and anode surface 53, and thereby increase the power density of the battery 1 relative to similar battery having planar cathode and anode surfaces.

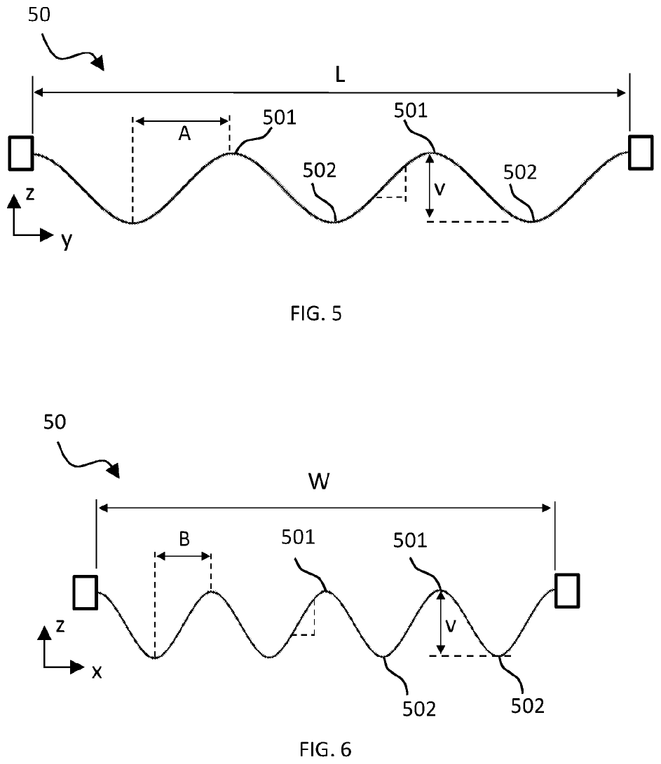

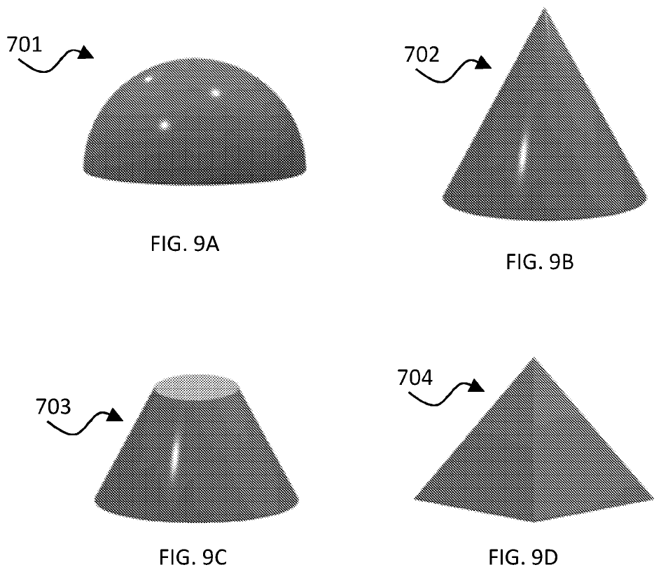

A cross-sectional view of one of the bipolar plates 50 taken in the y-z plane is shown in FIG. 5. As can be seen, the undulations provide the conductive polymer core 51 with a plurality of peaks 501 and troughs 502 which are spaced apart along the y-axis of the plate, which is the axis along which electrolyte flows in use. A cross-sectional view of the same bipolar plate 50 taken in the x-z plane is shown in FIG. 6. As can be seen, the undulations also provide the conductive polymer core 51 with a plurality of peaks 501 and troughs 502 which are spaced apart along x-axis of the plate, which is the axis oriented transversely to axis along which electrolyte flows in use. As illustrated in FIG. 5 and FIG. 6, the distance A between a peak 501 and a neighbouring trough 502 along the y-axis of the plate is greater than the distance B between a peak 501 and a neighbouring trough 502 along the y-axis of the plate, meaning that there are more peaks 501 and troughs 502 per unit width W of the conductive polymer core 51 than there are peaks 501 and troughs 502 per unit length L of the conductive polymer core 51. In this case, the height V measured along the z-axis between a peak 501 and a trough 502 is constant everywhere so that the magnitude of the maximum gradient of the conductive polymer core 51 along the width of the conductive polymer core 51 is greater than the magnitude of the maximum gradient of the conductive polymer core 51 along the length of the conductive polymer core 51. In other words, the undulations of the conductive polymer core 51 are steeper along the x-axis than along the y-axis. While providing a cathode surface 52 and anode surface 53 having undulations increases the surface area of those respective surfaces, and thereby the power density of the battery, the undulations increase the tortuosity of the electrolyte flow path between the surfaces. Having undulations which are too tightly spaced along the electrolyte flow path, or where the gradient of the plate along the flow path is too steep, can overly restrict fluid flow, which can adversely affect performance of the flow battery. However, over much of the cathode surface 52 and the anode surface 53, there is no substantial flow of electrolyte along the x-axis. The bipolar plates of the battery are therefore arranged with an increased cathode and anode surface area by providing a higher density of undulations along the x-axis, which is oriented substantially perpendicular to the axis of the general flow of electrolyte, than along the y-axis, which is oriented substantially parallel to the axis of electrolyte flow. While the conductive polymer core 51 of each of the bipolar plates described here comprises an egg-box-type truncated pyramidal arrangement of undulations, other embodiments may comprise other types of undulations in the x-y plane in order to increase the surface area of the plates. With reference to FIGS. 9A to 9D, these can include hemispherical 701, conical 702, frustoconical 703, pyramidal 704, or any other appropriate shape.

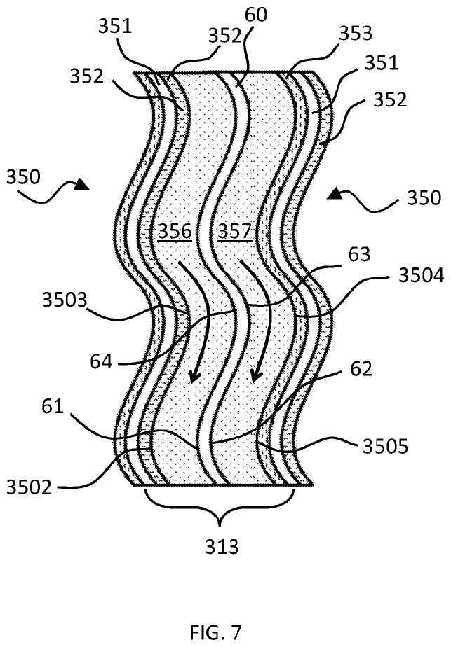

A cell 313 of a bipolar battery according to a second embodiment is shown in FIG. 7. The cell 313 has many features in common with the cell 13 of the battery according to the first embodiment, so where the cell 313 has features that are as described with respect to the cell 13, those features have been labelled with like reference numerals but prefixed with the number ‘3’.

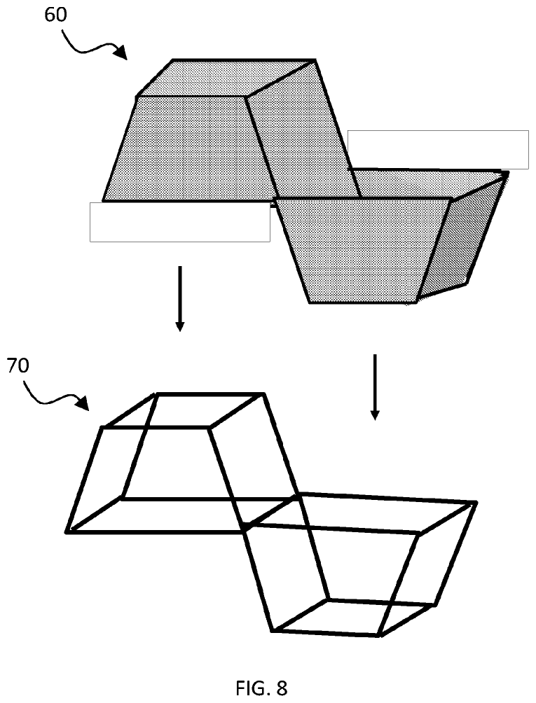

The cell 313 is formed by bipolar plates 350, and is filled with catholyte 356 and anolyte 357. A difference between the cell 313 and the cell 13 of the battery according to the first embodiment is that the separator membrane 60 of the cell 313 has been hot pressed to form a plurality of undulations which are complementarily shaped with respect to the undulations formed in the conductive polymer cores 351 of the bipolar plates. The membrane 60 has a substantially uniform thickness such that the locations of peaks 61, 63 on one side of the membrane 60 correspond to the locations of troughs 62, 64 on the opposite side of the membrane. The membrane 60 is held in its undulating form by a polymer lattice 70 over which the membrane 60 is placed, as shown in FIG. 8. The lattice 70 serves as a scaffold structure which secures the separator membrane 60 in place at a fixed distance from the cathode and anode surfaces 352, 353 to enable efficient ion exchange. The lattice structure is constructed from Acrylonitrile butadiene styrene, but in other embodiments may be constructed from another non-conductive material which remains inert in the chemical environment of the flow battery cell.

The undulations of the separator membrane 60 are aligned with the undulations of conductive polymer core 351 such that the peaks 61 formed by the separator membrane 60 on the cathode-side of the separator membrane 60 are received in the troughs 3502 formed by the cathode surface 352, and the peaks 3503 formed by the cathode surface 352 are received in troughs 64 formed by the separator membrane 60. The peaks 63 formed by the separator membrane 60 on the anode-side of the separator membrane 60 are received in troughs 3504 formed by the anode surface 353, and the peaks 3505 formed by the anode surface 353 are received in troughs 62 formed by the separator membrane 60. An undulating membrane 60 configured in this way enables the cathode and anode surfaces 352, 353 to be positioned closer together than in an arrangement having a planar membrane 54. The undulating membrane 60 therefore enables the size of the battery to be reduced relative to an arrangement having a planar membrane.

In some embodiments, the plates may be provided with undulations which are arranged to direct the electrolyte between a cell inlet 800 and a cell outlet 801 via more than one electrolyte flow channel, or, alternatively or additionally, via electrolyte flow channel(s) which change the direction in the x-y plane between the cell inlet 800 and cell outlet 801 so that the electrolyte flows along a non-linear path in the x-y plane between the cell inlet 800 and cell outlet 801. Such arrangements may be advantageous for controlling the fluid flow rate through the cells of the battery to enable a longer exposure of the ions to the cathode and anode surfaces, thereby optimizing the drawn energy from the electrolyte, and ensuring that the electrolyte is sufficiently depleted by the time it reaches the cell outlet 801.

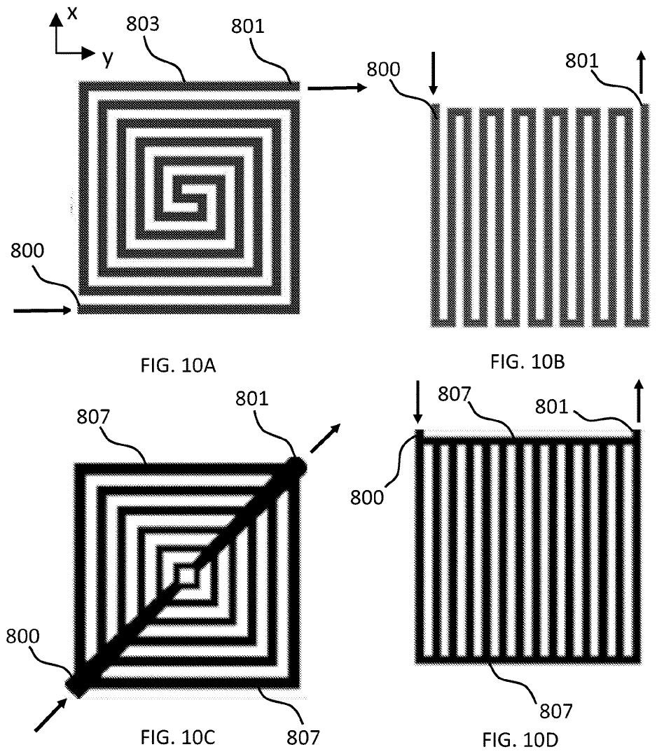

In some embodiments, the undulations of the bipolar plates and, optionally, a membrane between the plates, may be shaped to restrict the net fluid flow between the cell inlet 800 and cell outlet 801 to spiral-shaped flow channel 805 in the x-y plane, as shown in FIG. 10A, or to a serpentine flow channel 806, as shown in FIG.

10B. In embodiments comprising a membrane, the membrane may have undulations which are complementarily shaped to those of the bipolar plates and the membrane may be positioned equidistantly between the bipolar plates. In other embodiments, the undulations of the bipolar plates and, optionally, a membrane between the plates, may be shaped to direct the fluid flow between the cell inlet and the cell outlet along multiple flow channels 807, such as the parallel Murray pattern shown in FIG. 10C or the parallel pattern shown in FIG. 10D.

Where in the foregoing description, integers or elements are mentioned which have known, obvious or foreseeable equivalents, then such equivalents are herein incorporated as if individually set forth. It will also be appreciated that integers or features that are described as preferable, advantageous, convenient or the like are optional and do not limit the scope of the claims. Moreover, it is to be understood that such optional integers or features, whilst of possible benefit in some embodiments, may not be desirable, and may therefore be absent, in other embodiments.

1. A flow battery comprising:
a first conductive plate; and
a second conductive plate,
wherein each of the first and second conductive plates comprises an undulating surface formed with a first plurality of undulations which extend along a first axis of the conductive plate, and a second plurality of undulations which extend along a second, perpendicular axis of the conductive plate, and
wherein the first and second conductive plates are arranged to form a first cell of the flow battery in which the respective undulating surfaces of the first and second conductive plates provide a cathode and a corresponding anode of the first cell, and define opposing walls of an electrolyte flow channel between the first and second conductive plates.

2. The flow battery according to claim 1, wherein the undulating surface of at least one of the first and second conductive plates comprises a first plurality of peaks and troughs which extend along the first axis of the conductive plate, and a second plurality of peaks and troughs which extend along the second axis of the conductive plate, wherein a distance between a peak and an adjacent trough of the first plurality is different to a distance between a peak and an adjacent trough of the second plurality.

3. The flow battery according to claim 2, wherein the first and second conductive plates are arranged such that their respective first axes are oriented substantially parallel with a flow axis along which electrolyte flows through the electrolyte flow channel, and wherein the distance along the first axis between a peak and an adjacent trough of the first plurality is greater than a distance along the second axis between a peak and an adjacent trough of the second plurality.

4. The flow battery according to claim 1, wherein the undulating surface of at least one of the first and second conductive plates comprises a first plurality of peaks and troughs which extend along the first axis of the conductive plate, and a second plurality of peaks and troughs which extend along the second axis of the conductive plate, wherein the magnitude of the maximum gradient of the undulating surface between a peak and a trough of the first plurality is different from the magnitude of the maximum gradient of the undulating surface between a peak and a trough of the second plurality.

5. The flow battery according to claim 4, wherein the first and second conductive plates are arranged such that their respective first axes are oriented substantially parallel with a flow axis along which electrolyte flows through the electrolyte flow channel, and wherein the magnitude of the maximum gradient of the undulating surface between a peak and a trough of the first plurality is less than the magnitude of the maximum gradient of the undulating surface between a peak and a trough of the second plurality.

6. The flow battery according to claim 1, wherein at least one of the first and second conductive plates is an undulating plate having undulating surfaces on opposing sides of the plate.

7. The flow battery according to claim 6, comprising a third conductive plate, wherein the second and third conductive plates are arranged to form a second cell of the flow battery in which the respective undulating surfaces of the second and third conductive plates provide a cathode and a corresponding anode of the second cell and define opposing walls of an electrolyte flow channel between the second and third conductive plates, the second conductive plate thereby forming an anode of one of the first and second cells and a cathode of the other of the first and second cells.

8. The flow battery according to claim 6 or claim 7, wherein the second conductive plate is a bipolar plate comprising a conductive polymer core comprising an undulating anode surface and an undulating cathode surface on opposing surfaces thereof.

9. The flow battery according to claim 8, wherein the conductive polymer core comprises a conductive composite comprising a polymer and conductive filler particles distributed substantially uniformly throughout the polymer.

10. (canceled)

11. The flow battery according to claim 1, comprising a separator membrane between the first and second conductive plates, the battery thereby being configured with a catholyte flow channel between the cathode surface and the separator membrane on a first side of the separator membrane and with an anolyte flow channel between the anode surface and the separator membrane on a second, opposite side of the separator membrane.

12. The flow battery according to claim 11, wherein the membrane is formed with a first plurality of undulations which extend along a first axis of the membrane, and with a second plurality of undulations which extend along a second, perpendicular axis of the membrane.

13. The flow battery according to claim 12, wherein the undulations formed in the membrane are complementarily shaped with respect to the undulating surface of at least one of the first and second conductive plates, and the membrane is arranged such that a peak of the undulating surface of the membrane is received within a trough of the undulating surface of the at least one of the first and second conductive plates or such that a peak of at least one of the first and second conductive plates received within a trough of the undulating surface of the membrane.

14. (canceled)

15. The flow battery according to claim 12, wherein the membrane is supported by a lattice structure formed with a plurality of undulations which are complementarily shaped with respect to the undulations formed in the membrane, and wherein a surface of the membrane is supported upon the lattice structure such that a peak of the lattice structure is received within a trough on of the surface of the membrane and such that a peak on the surface of the membrane is received within a trough of the lattice structure.

16. The flow battery according to claim 1, wherein the first cell comprises a cell inlet through which electrolyte is provided to the cell and a cell outlet through which electrolyte leaves the cell, and wherein the undulating surfaces of the first and second conductive plates are configured such that the electrolyte flow channel changes direction in an x-y plane between the cell inlet and cell outlet.

17. The flow battery according to claim 1, wherein the first cell comprises a cell inlet through which electrolyte is provided to the cell and a cell outlet through which electrolyte leaves the cell, and wherein the undulating surfaces of the first and second conductive plates are configured such that two or more electrolyte flow channels are provided between the cell inlet and cell outlet.

18. A conductive plate for a flow battery, the conductive plate formed from a conductive composite, the conductive composite comprising:
a polymer; and
conductive filler particles distributed substantially uniformly throughout the polymer,
wherein the conductive composite forms a conductive polymer core of the conductive plate, and
wherein the conductive plate comprises an undulating surface formed with a first plurality of undulations which extend along a first axis of the conductive plate, and a second plurality of undulations which extend along a second, perpendicular axis of the conductive plate.

19. The conductive plate according to claim 18, wherein the polymer comprises one or more of acrylonitrile butadiene styrene (ABS), polysulphone (PSU), polyethersulphone (PESU) or polyphenylsulphone (PPS).

20. The conductive plate according to claim 18, comprising conductive filler particles by volume between 2% and 50%.

21. The conductive plate according to claim 18, wherein the conductive filler particles may have a diameter of up to 50 μm.

22. (canceled)

23. The vehicle comprising a flow battery according to claim 1, for example wherein the vehicle is a road vehicle, optionally an electric or hybrid vehicle.

24. (canceled)

25. (canceled)
